(19) United States
(12) Patent Application Publication
(10) Pub. No.: US 2026/0163021 A1
(43) Pub. Date: Jun. 11, 2026

(54) SEPARATOR FOR ELECTROCHEMICAL DEVICE, ELECTROCHEMICAL DEVICE

(71) Applicant: SAMSUNG ELECTRO-MECHANICS CO., LTD., Suwon-si (KR)

(72) Inventors: Yusung Kim, Suwon-si (KR); Jung Deok Park, Suwon-si (KR)

(73) Assignee: SAMSUNG ELECTRO-MECHANICS CO., LTD., Suwon-si (KR)

(21) Appl. No.: 19/335,927

(22) Filed: Sep. 22, 2025

(30) Foreign Application Priority Data
Dec. 5, 2024 (KR) 10-2024-0179388
Jan. 31, 2025 (KR) 10-2025-0012706

(51) Int. Cl. H01M 8/0247; C25B 13/02; H01M 8/0258

(52) U.S. Cl. CPC H01M 8/0247; C25B 13/02; H01M 8/0258

(57) ABSTRACT

A separator for an electrochemical device may include a main plate; and a plurality of walls disposed on one or both of a first surface and a second surface of the main plate. The plurality of walls include a plurality of first walls having a shape extending in a first direction, and a plurality of second walls having a shape extending in a second direction, different from the first direction, wherein, among the plurality of first walls, some regions of two adjacent first walls overlap each other in a direction, perpendicular to the first direction and the remaining regions of two adjacent first walls do not overlap each other, and wherein, among the plurality of second walls, some regions of two adjacent second walls overlap each other in a direction, perpendicular to the second direction and the remaining regions of two adjacent second walls do not overlap each other.

### CROSS-REFERENCE TO RELATED APPLICATION(S)

This application claims the benefit of priority to Korean Patent Application Nos. 10-2024-0179388 filed on Dec. 5, 2024 in the Korean Intellectual Property Office and 10-2025-0012706 filed on Jan. 31, 2025 in the Korean Intellectual Property Office, the disclosures of which are incorporated herein by reference in its entirety.

### TECHNICAL FIELD

The present disclosure relates to a separator for an electrochemical device and an electrochemical device.

### BACKGROUND

An electrochemical device includes a fuel cell generating electrical energy by electrochemically reacting fuel (hydrogen) and an oxidizer (e.g., pure oxygen or oxygen in the air), and an electrolytic cell generating hydrogen and oxygen through the electrolysis of water.

As examples of such an electrochemical device, a solid oxide fuel cell (SOFC) and a solid oxide electrolysis cell (SOEC) include a cell comprised of an air electrode, a fuel electrode, and a solid oxide electrolyte having oxygen ion conductivity, and the cell may be referred to as a solid oxide cell. A solid oxide cell produces electrical energy through an electrochemical reaction or produces hydrogen by electrolyzing water in a reverse reaction of the solid oxide fuel cell. In addition thereto, other types of fuel cells or electrolytic cells, such as a phosphoric acid fuel cell (PAFC), an alkaline fuel cell (AFC), a polymer electrolyte membrane fuel cell (PEMFC), and a direct methanol fuel cell (DMFC), are also used as a type of electrochemical device.

In the case of an electrochemical device, the electrochemical device is commonly used as a stack structure in which unit cells are disposed between a pair of separators, where the separators may electrically connect the cells in series. Since bending force, or the like, may be applied to the separator during a manufacturing process or operation of the electrochemical device, a method to secure the structural stability of the separator is required. In particular, when the separator is manufactured thinly, a moment of inertia is low, so the influence of the bending force may be further increased.

### SUMMARY

An aspect of the present disclosure is to provide a separator for an electrochemical device of which structural stability may be improved when applied to an electrochemical device.

According to an aspect of the present disclosure, provided is a separator for an electrochemical device, the separator for an electrochemical device including: a main plate, and a plurality of walls disposed on at least one of a first surface and a second surface of the main plate opposing each other, wherein the plurality of walls include a plurality of first walls having a shape extending in a first direction and a plurality of second walls having a shape extending in a second direction, different from the first direction, wherein, among the plurality of first walls, some regions of two adjacent first walls overlap each other in a direction, perpendicular to the first direction and the remaining regions of two adjacent first walls do not overlap each other, and among the plurality of second walls, some regions of two adjacent second walls overlap each other in a direction, perpendicular to the second direction and the remaining regions of two adjacent second walls do not overlap each other.

According to another aspect of the present disclosure, provided is a separator for an electrochemical device, the separator for an electrochemical device including: a main plate, and a plurality of walls disposed on at least one of a first surface and a second surface of the main plate, opposing each other, wherein the plurality of walls include a plurality of first walls having a shape extending in a first direction, wherein, among the plurality of first walls, at least two adjacent first walls protrude in opposite directions with respect to the main plate, and some regions of at least two adjacent first walls overlap each other in a direction, perpendicular to the first direction, and the remaining regions at least two adjacent first walls do not overlap each other.

According to another aspect of the present disclosure, provided is a separator for an electrochemical device, the separator for an electrochemical device including: a main plate, and a plurality of walls disposed on at least one of a first surface and a second surface of the main plate, opposing each other, wherein, when a region excluding an outermost side of the main plate in which the plurality of walls do not exist is referred to as a flow path region, based on a plan view, viewed in a direction perpendicular to the first surface and the second surface of the main plate, all straight lines passing through a center of the flow path region meet at least one of the plurality of walls.

According to another aspect of the present disclosure, provided is an electrochemical device, the electrochemical device including: a plurality of separators, and an electrochemical cell disposed between the plurality of separators, wherein at least one of the plurality of separators includes a main plate and a plurality of walls disposed on at least one of a first surface and a second surface of the main plate opposing each other, wherein the plurality of walls include a plurality of first walls having a shape extending in a first direction and a plurality of second walls having a shape extending in a second direction, different from the first direction, wherein, among the plurality of first walls, some regions of two adjacent first walls overlap each other in the second direction and the remaining regions of two adjacent first walls do not overlap each other, and among the plurality of second walls, some regions of two adjacent second walls overlap each other in the first direction and the remaining regions of two adjacent second walls do not overlap each other.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating the exterior of a separator for an electrochemical device according to an embodiment of the present disclosure;

FIG. 2 is a plan view of the separator for an electrochemical device of FIG. 1 viewed in one direction;

FIG. 3 is a cross-sectional view of a region of the separator for the electrochemical device of FIG. 1;

FIG. 4 illustrates a unit including a plurality of walls;

FIG. 5 illustrates a separator having a wall structure according to the prior art; FIG. 6 illustrates a separator having a wall structure according to an embodiment of the present disclosure;

FIGS. 7, 8, 9, 10 and 11 illustrate a separator for an electrochemical device according to a modified example, respectively; and

FIG. 12 illustrates a water electrolysis device to which a separator according to an embodiment of the present disclosure is applied.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

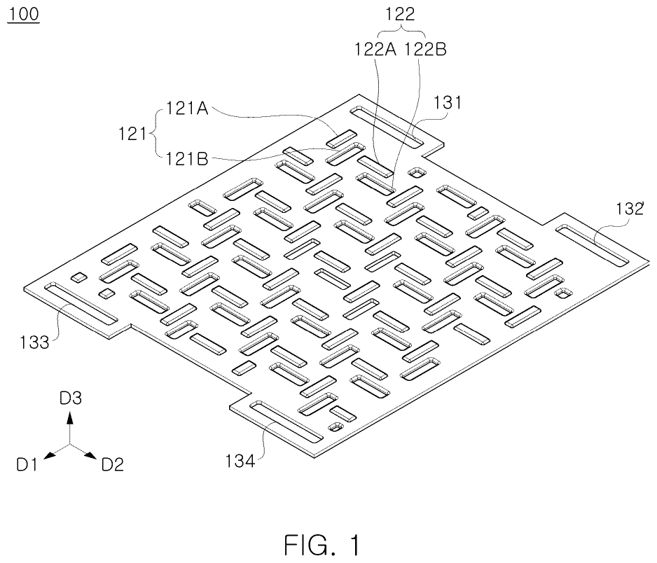

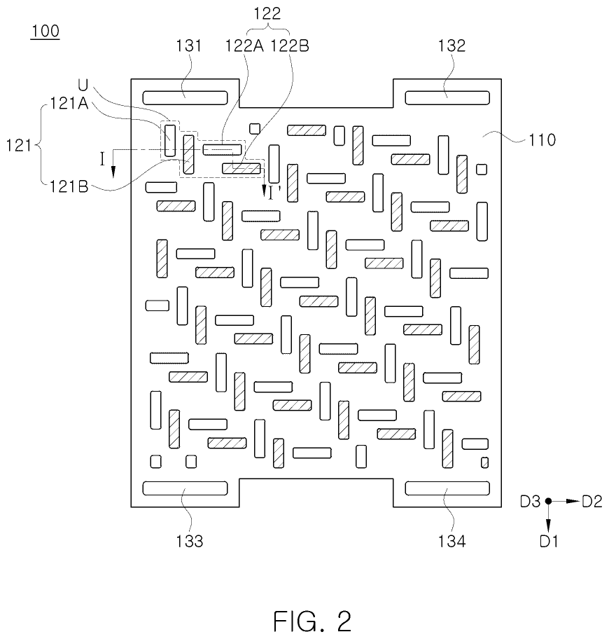

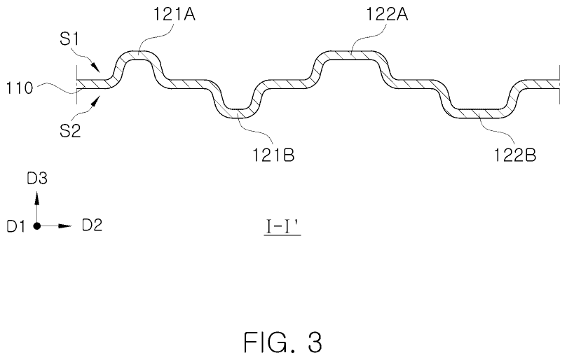

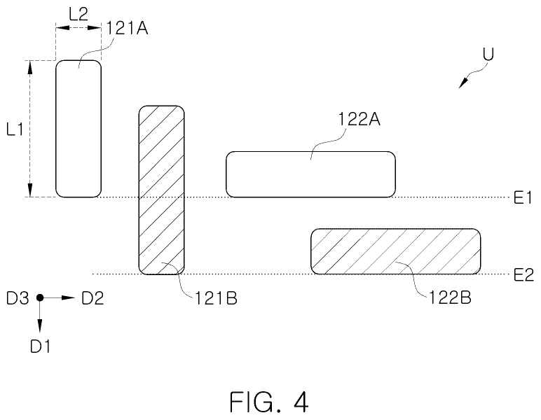

FIG. 1 is a perspective view schematically illustrating the exterior of a separator for an electrochemical device according to an embodiment of the present disclosure. FIG. 2 is a plan view of the separator for the electrochemical device of FIG. 1 viewed in one direction, and FIG. 3 is a cross-sectional view of a region of the separator for an electrochemical device of FIG. 1. FIG. 4 illustrates a unit including a plurality of walls.

Referring to FIGS. 1 to 4, a separator 100 for an electrochemical device according to an embodiment of the present disclosure (hereinafter, referred to as a “separator for an electrochemical device” or a “separator”) includes a main plate 110 and a plurality of walls 121 and 122 disposed on at least one surface of a first surface S1 and a second surface S2 of the main plate 110, opposing each other, wherein, the plurality of walls 121 and 122 include a plurality of first walls 121 having a shape extending in a first direction D1 and a plurality of second walls 122 having a shape extending in a second direction D2, different from the first direction D1. Among the plurality of first walls 121, some regions of two adjacent first walls 121 overlap each other in a direction, perpendicular to the first direction D1 and the remaining regions thereof do not overlap each other. In addition, among the plurality of second walls 122, some regions of two adjacent second walls 122 overlap each other in a direction, perpendicular to the second direction D2 and the remaining regions thereof do not overlap each other. As described above, as the first walls 121 partially overlap each other, and the second walls 122 partially overlap each other, a region vulnerable to bending force in the main plate 110 may be minimized, and further, such a vulnerable region may be prevented from existing. Therefrom, the rigidity of the main plate 110 against the bending force may be improved, thereby improving the structural stability of the separator 100, and details thereof will be described later.

The main plate 110 comprising the separator 100 may be formed of a conductive material as a component which separates respective unit cells in an electrochemical device. Specifically, when the main plate 110 is used as a SOEC or SOFC, the main plate 110 may include a metal with a high melting point so as not to melt or soften at high temperatures. For example, the main plate 110 may use materials such as nickel-based, iron-based, and stainless-based materials. In addition, when an operating temperature of the main plate 110 is relatively low, for example, at about 800° C. or lower, copper or copper alloys with good conductivity may also be used. The main plate 110 may include a plurality of through-holes 131, 132, 133, and 134 as fluid inlets and outlets. In this case, as in the illustrated form, the plurality of through-holes 131, 132, 133, and 134 may be disposed on the outside of the main plate 110 in the first direction D1. Fluid may flow in and out through the plurality of through-holes 131, 132, 133, and 134 and flow along a space between the plurality of walls 121 and 122. In this case, a separator 100 may be utilized so that the through-holes 131, 132, 133, and 134, facing each other diagonally serve as fluid inlets and outlets, to smooth a flow of fluid throughout the entire region of the separator 100. For example, when the separator 100 is used as a fuel electrode side separator of a water electrolysis cell, the first through-hole 131 and the fourth through-hole 134 may be used as a fuel inlet and a fuel outlet, respectively. In addition, when the separator 100 is used as an air electrode side separator, the second through-hole 132 and the third through-hole 133 may be used as an air inlet and an air outlet, respectively.

A plurality of walls 121 and 122 may be disposed on at least one surface of the first surface S1 and the second surface S2 of the main plate 110, opposing each other, and thus a flow path through which fluid may flow may be formed in a region other than the plurality of walls 121 and 122. In the present embodiment, walls 121 and 122 may be disposed on both the first surface S1 and the second surface S2 of the main plate 111, but in some cases, the walls 121 and 122 may be disposed on only one of these surfaces. The plurality of walls 121 and 122 may be adopted in any form as long as they are structures protruding from the main plate 110, and as in the present embodiment, the main plate 110 and the plurality of walls 121 and 122 may form an integral structure. In this case, the plurality of walls 121 and 122 may be effectively obtained by a method of stamping the main plate 110, a method of manufacturing the separator 100 by hydroforming to have a plurality of walls 121 and 122, and the like. In the case of the plurality of walls 121 and 122 thus obtained, the first surface S1 and the second surface S2 of the main plate 110 may have a shape protruding in the same direction, as illustrated in FIG. 3. In other words, in the case of the walls 121A and 122A disposed on the first surface S1 of the main plate 110, the first surface S1 and the second surface S2 thereof may have a shape protruding upwardly based on FIG. 3. In addition, in the case of the walls 121B and 122B disposed on the second surface S2 of the main plate 110, the first surface S1 and the second surface S2 thereof may have a shape protruding downwardly.

As described above, the plurality of first walls 121 have a shape extending in a first direction D1, and the plurality of second walls 122 have a shape extending in a second direction D2. Here, the first direction D1 and the second direction D2 may be different directions, and for example, an angle formed by the first direction D1 and the second direction D2 may be 45 degrees or more. As a more specific example, as in the present embodiment, the first direction D1 and the second direction D2 may be perpendicular to each other. Here, a third direction D3 may be defined as a direction perpendicular to the first direction D1 and the second direction D2. Hereinafter, it is described that the first direction D1 and the second direction D2 are perpendicular to each other, but depending on the embodiment, the first direction D1 and the second direction D2 may not be perpendicular to each other.

Referring to FIG. 4, the extension of the first wall 121 in the first direction D1 may be defined as a length L1 in the first direction D1 being longer than the length L1 in a direction perpendicular thereto, that is, in the present embodiment, the length L2 in the second direction D2. Similarly, the extension of the second wall 122 in the second direction D2 may be defined as a length L2 in the second direction D2 being longer than the length L1 in a direction perpendicular thereto, that is, in the present embodiment, the length L1 in the first direction D1. In the present embodiment, the bending rigidity of the separator 100 may be improved by adopting a partial overlap structure for each of the first wall 121 and the second wall 122, adjacent to each other. Specifically, referring to FIG. 2, among the plurality of first walls 121, some regions of two adjacent first walls 121 overlap each other to partially overlap in the second direction D2 and the remaining regions thereof do not overlap each other. In addition, among the plurality of second walls 122, some regions of two adjacent second walls 122 overlap each other to partially overlap in the first direction D1 and the remaining regions thereof do not overlap each other. In this case, the plurality of walls 121 and 122 may include a region in which a unit U is repeated, wherein the unit U may include two first walls 121 and two second walls 122 adjacent to each other. A plurality of these units U may be provided and disposed regularly. In this case, when a region excluding an outermost side of the main plate 110 in which the plurality of walls 121 and 122 do not exist in the main plate 110 is referred to as a flow path region (F in FIG. 6), since it may be difficult to dispose the unit U as it is disposed on an outermost side of the flow path region F, only a portion of the unit U may be present or the walls 121 and 122 may be provided in a form with a reduced size compared to other regions.

Looking specifically at the form of the unit U, second walls 122A and 122B may not be disposed between the two first walls 121A and 121B in the unit U. Similarly, the first walls 121A and 121B may not be disposed between the two second walls 122A and 122B. In this case, two first walls 121 in the unit U may protrude from the main plate 110 in opposite directions. That is, with reference to FIG. 3, one 121A of the first walls 121 may protrude upwardly and the other 121B may protrude downwardly. As described above, when the first walls 121 are disposed to protrude in opposite directions from the main plate 110 and partially overlap each other, a flow path may be effectively formed on both of the first and second surfaces S1 and S2 of the main plate 110, and the rigidity against bending force may also be increased as described later. Here, the flow paths formed on both of the first and second surfaces S1 and S2 of the main plate 110 may be used as a fuel electrode path and an air electrode path, respectively.

Similar to the dispositional method of the first wall 121, in the unit U, two second walls 122A and 122B may protrude in opposite directions from the main plate 110. That is, with reference to FIG. 3, the second wall 122 may protrude upwardly and the second wall 122B may protrude downwardly. Accordingly, the first wall 121A and the second wall 122A may protrude in the same direction, and the first wall 121B and the second wall 122B may protrude in the same direction. By including the walls 121 and 122 protruding on both sides of the main plate 110, a flow path is formed on both sides of the separator 100, so that the separator 100 may function as a bipolar plate. In the following description, the first wall and the second wall disposed on the first surface S1 of the main plate 110 will be referred to as 121A and 122A, respectively, and the first wall and the second wall disposed on the second surface S2 of the main plate 110 will be referred to as 121B and 122B, respectively.

As shown in the form illustrated in FIG. 4, in the unit U, among the plurality of walls 121 and 122, the walls protruding in the same direction may have one side surface disposed on the same level. Specifically, the first wall 121A and the second wall 122A disposed on the first surface S1 of the main plate 110 may have one side surface disposed on the same level E1 based on the first direction D1. Similarly, in the unit U, the first wall 121A and the second wall 122A disposed on the second surface S2 of the main plate 110 may may have one side surface disposed on the same level E2 with respect to the first direction D1. Furthermore, in the unit U, the first wall 121A disposed on the first surface S1 of the main plate 110 may overlap all regions of the second wall 122A disposed on the first surface S1 of the main plate 110 in the second direction D2. In addition, in the unit U, the first wall 121B disposed on the second surface S2 of the main plate 110 may overlap all regions of the second wall 122B disposed on the second surface S2 of the main plate 110 in the second direction D2. The region in which the walls 121A, 121B, 122A, and 122B do not exist in the main plate 110 may be vulnerable to bending force because a moment of inertia is relatively low. However, by the dispositional method as shown in FIG. 4, there may not be a straight line in the second direction D2 within the unit U that does not meet any of the walls 121A, 121B, 122A, and 122B. Therefore, the influence of the bending force acting around the straight line in the second direction D2 may be reduced.

A plurality of units U including a plurality of walls 121 and 122 may be provided and disposed repeatedly. Specifically, as shown in FIGS. 1 and 2, the plurality of units U may be disposed repeatedly in a diagonal direction between the first direction D1 and the second direction D2. Accordingly, when the main plate 110 is viewed as a whole, a plurality of first walls 121A and 121B protruding in opposite directions may be arranged alternately in an inclined direction with respect to the first direction D1. In addition, when the main plate 110 is viewed as a whole, some regions of the plurality of first walls 121 may overlap two other adjacent first walls 121 in a direction, perpendicular to the first direction D1 (D2 in this embodiment), and the remaining regions of the plurality of first walls 121 may not overlap each other. In this case, a plurality of second walls 122 may be disposed between the plurality of first walls 121.

As described above, when including a unit U of the same shape as in FIG. 4, by arranging a plurality of units U in a diagonal direction rather than in the first direction D1 or the second direction D2, it is possible to minimize a vulnerable region in which walls 121 and 122 do not exist in a straight line in a specific direction within the main plate 110. In this case, one of the plurality of units U may have a first wall 121 included therein that can at least partially overlap a second wall 122 included in the other unit U in the first direction D1. Accordingly, the influence of the bending force acting around the straight line in the first direction D1 may also be reduced.

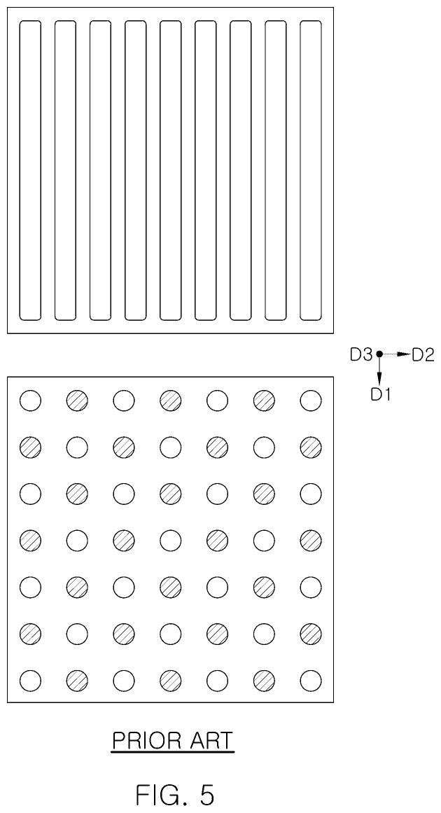

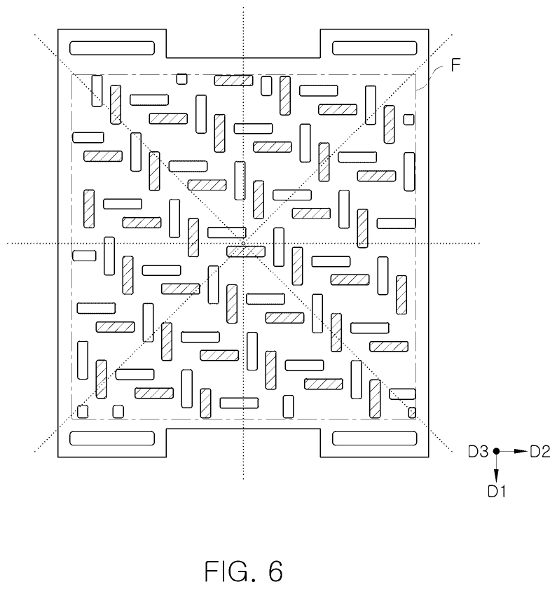

Referring to FIGS. 5 and 6, an effect of improving rigidity of a separator having a wall structure according to the present disclosure is described. FIG. 5 illustrates a separator having a wall structure according to the prior art, the upper portion corresponds to a straight wall, and the lower portion corresponds to a dot-shaped wall. FIG. 6 illustrates a separator according to an embodiment of the present disclosure described above. A separator using a straight wall, as in the prior art, is vulnerable to bending force (arrow) centered on a straight line in the first direction D1, and the separator by the dot-shaped wall is vulnerable to bending force (arrow) centered on a straight line in the first direction D1 and the second direction (D2), as well as in the direction therebetween. Therefore, when such a separator is adopted, there is a problem of low structural stability due to vulnerability to an influence such as bending force applied during the manufacturing or operation of an electrochemical device. In comparison thereto, referring to FIG. 2 and FIG. 6 together, in the separator according to the present embodiment, the shape and dispositional method of the walls 121 and 122 are designed so as to minimize a region vulnerable to bending force. Here, the region vulnerable to bending force may be seen as a region in which there is a straight line that does not meet any of the walls 121 and 122, passing through the center of the flow path region F, and as the number of such vulnerable regions increases, structural stability of the separator may decrease.

In the present embodiment, by adopting the partial overlap structure of the walls 121 and 122 described above, a region vulnerable to bending force may be minimized, and ideally, such a vulnerable region may be avoided. This corresponds to the case in which, as shown in FIG. 6, in a flow path region F, which is a region excluding the outermost side of the main plate 110 in which the plurality of walls 121 and 122 do not exist on the main plate 110, based on the plan view in the direction D3 perpendicular to the first surface S1 and the second surface S2 of the main plate 110, all straight lines passing through the center of the main plate 110 meet at least one of the walls 121 and 122 among the plurality of walls 121 and 122. Furthermore, when all straight lines passing through the flow path region F meet at least one of the walls 121 and 122 among the plurality of walls 121 and 122, the rigidity against bending force may be further improved. In a form in which there is no region vulnerable to bending force, it can be said that individual shapes and dispositional methods of the walls 121 and 122 are not particularly limited. In this case, the first wall 121 does not necessarily need to be a straight wall extending in the first direction D1, and similarly, the second wall 122 does not necessarily need to be a wall extending in the second direction D2.

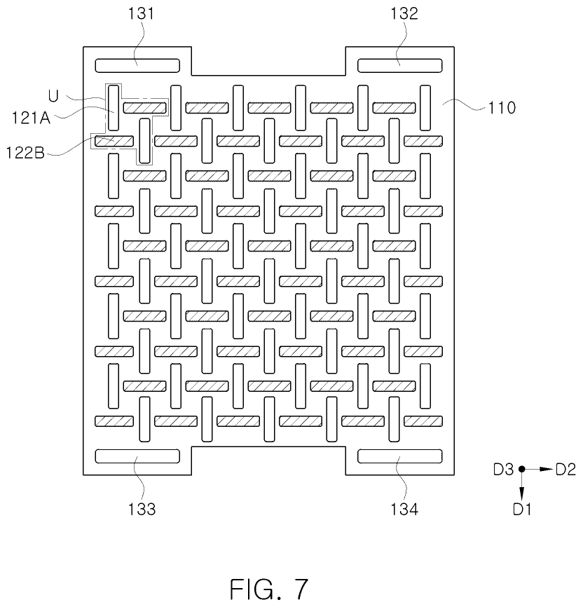

Hereinafter, a separator for an electrochemical device according to a modified example will be described with reference to FIGS. 7 to 11. First, in the case of the modified example of FIG. 7, there is a difference from the previous embodiment in terms of an internal structure of a unit U and a manner in which a plurality of units U are arranged. Specifically, in the unit U, a second wall 122B is disposed at a position adjacent to a first wall 121A in a first direction D1 and at a position adjacent to the first wall 121A in a second direction D2. In this case, in the unit U, some regions of the first wall 121A may overlap the second wall 122B adjacent thereto in the first direction D1, and the remaining regions thereof may not overlap the second wall 122B. In addition, in the unit U, some regions of the first wall 121A may overlap the second wall 122B adjacent thereto in the second direction D2, and the remaining regions thereof may not overlap the second wall 122B. The two first walls 121A may have a partial overlap structure, as in the embodiment above, that is, some regions of two first walls 121A may overlap each other in a direction, perpendicular to the first direction D1 (D2 in the present embodiment) and the remaining regions thereof may not overlap each other. Thereby, in the unit U, the two first walls 121A may be spaced apart from each other in a diagonal direction between the first direction D1 and the second direction D2. By disposing the walls 121A and 122B like the example of FIG. 7, a region vulnerable to bending force within the unit U may be minimized. For example, based on a plan view, viewed in direction perpendicular to the first surface S1 and the second surface S2 of the main plate 110, straight lines passing through at least one unit U among the plurality of units U may meet at least one of the walls 121B and 122A among the plurality of walls 121B and 122A.

In the embodiment of FIG. 7, the manner in which the first wall 121A and the second wall 122B protrude may be different from the previous embodiment. Specifically, in the unit U, the first wall 121A and the second wall 122B may protrude in opposite directions with respect to the main plate 110. In this case, in the unit U, the two first walls 121A may protrude in the same direction with respect to the main plate 110, for example, toward the first surface S1 of the main plate 110, and in addition, in the unit U, the two second walls 122B may protrude in the same direction with respect to the main plate 110, for example, toward the second surface S2 of the main plate 110. The plurality of units U may be arranged repeatedly in the first direction D1 and the second direction D2.

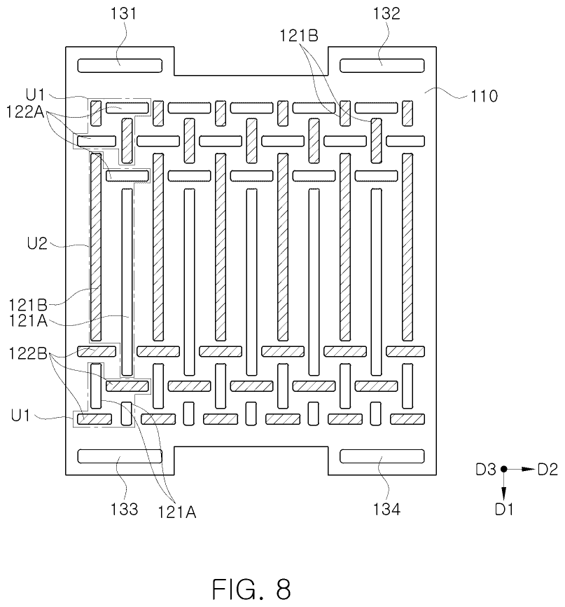

Next, in the case of the embodiment of FIG. 8, the structure includes walls having different lengths to effectively induce a flow of fluid from a fluid inlet to a fluid outlet. Referring to FIG. 8, the plurality of units U include a first unit U1 and a second unit U2, and a length of the first walls 121A and 121B included in the second unit U2 in the first direction D1 is longer than a length of the first wall 121B included in the first unit U1 in the first direction D1. In this case, the first unit U1 having a relatively short length of the first wall 121A may be arranged repeatedly in the second direction D2. In the case of the second unit U2 in which the length of the first walls 121A and 121B is relatively long, the first walls 121A and 121B included therein may protrude in different directions with respect to the main plate 110. In this case, a plurality of second units U2 may be provided, and the plurality of second units U2 may be arranged in the second direction D2. As shown in the illustrated form, the first unit U1 may be disposed on both sides (upper and lower sides of the main plate 110 based on FIG. 8) in the first direction D1, and the second unit U2 may be disposed between the first unit U1 disposed on both sides of the main plate 110.

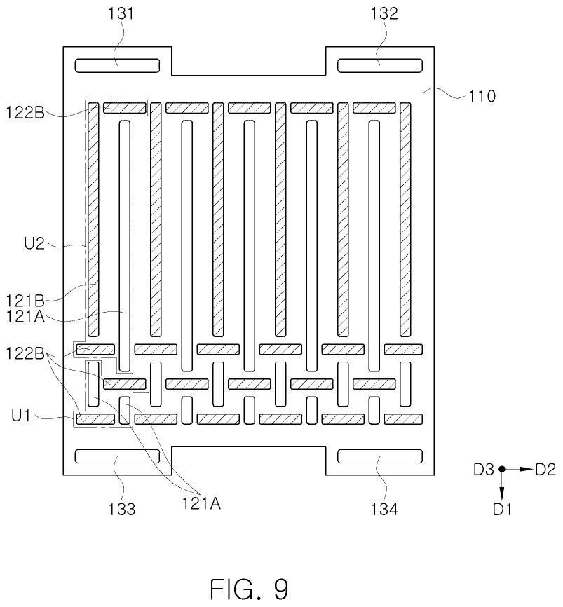

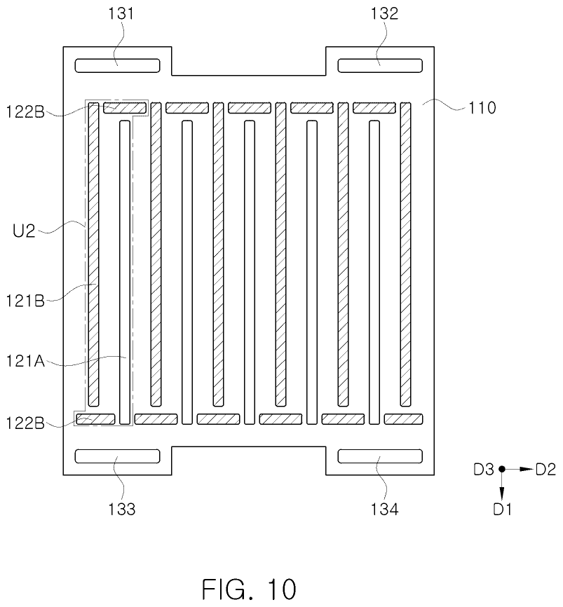

FIGS. 9 and 10 illustrate a second unit U2 in an extended form in the embodiment of FIG. 8. In a modified example of FIG. 9, the first unit U1 may be disposed on a first side of the main plate 110 (a lower side of the main plate 110 based on FIG. 9) in a first direction D1, and the second unit U2 may be disposed on a second side of the main plate 110 (an upper side of the main plate 110 based on FIG. 9) in the first direction D1. Further, as in the modified example of FIG. 10, the second unit U2 may be extended to both sides of the main plate 110. In the case of the embodiments of FIGS. 9 and 10, the plurality of units U1 and U2 may be disposed in a second direction D2 and may not be repeated in the first direction D1.

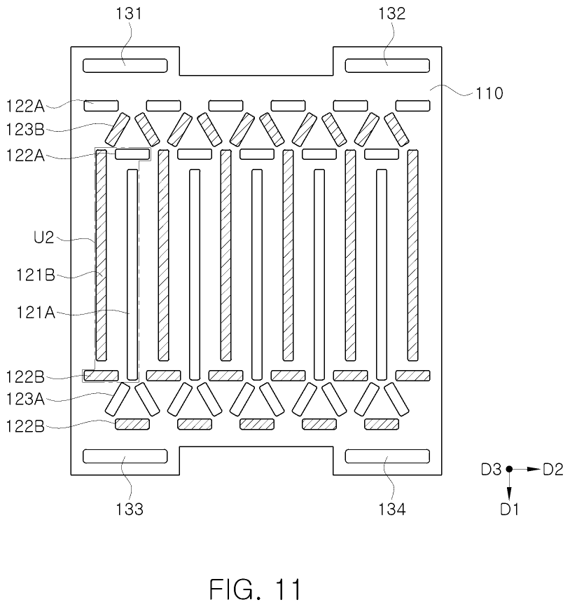

Next, in the case of the modified example of FIG. 11, in addition to the first and second walls 121 and 122, third walls 123A and 123B having a shape extending in different directions is further included. Specifically, the plurality of walls 121, 122, and 123 may further include a plurality of third walls 123A and 123B having a shape extending in a direction inclined with respect to the first direction D1 and the second direction D2. In this case, at least two third walls 123A and 123B among the plurality of third walls 123A and 123B may have different inclined directions with respect to the first direction D1 and the second direction D2. Here, a plurality of third walls 123A and 123B may be disposed on both sides (upper and lower sides of the main plate 110 based on FIG. 11) in the first direction D1, and the unit U2 may be disposed between the plurality of third walls 123A and 123B disposed on both sides of the main plate 110 in the first direction D1. Among the plurality of third walls 123A and 123B, a third wall 123A disposed on one side (a lower side of the main plate 110 based on FIG. 11) in the first direction D1 and a third wall 123B disposed on the other side (an upper side of the main plate 110 may protrude in opposite directions with respect to the main plate 110. As illustrated in the present embodiment, by disposing the third walls 123A and 123B having an inclined form on both sides of the main plate 110 in which the influence of bending force is relatively low, but the density of fluid is relatively high, the flowability of fluid may be improved.

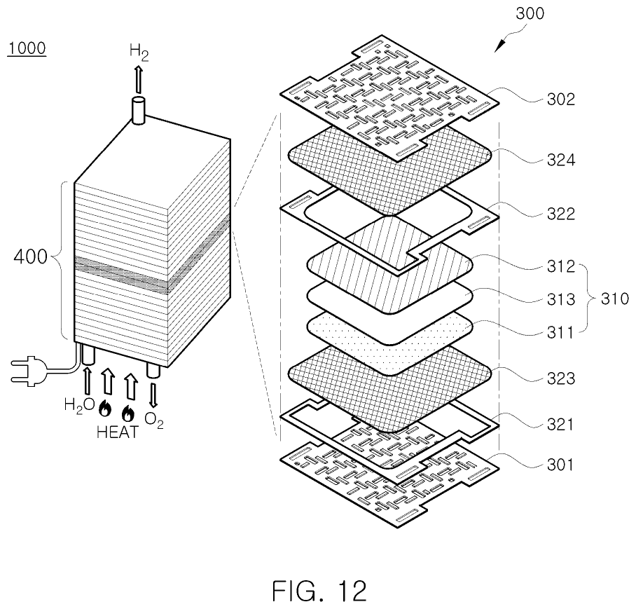

An example of applying the separator described above to an electrochemical device is described with reference to FIG. 12. FIG. 12 illustrates a water electrolysis device to which a separator is applied, including the wall structure described above, and structural stability may be improved. However, the above-described type of separator may be applied to other types of electrochemical devices, such as a fuel cell, rather than a water electrolysis device. Referring to FIG. 12, the water electrolysis device 1000 includes a plurality of separators 301 and 302 and an electrochemical cell 310 disposed therebetween. The water electrolysis device 1000 may be supplied with water in the form of steam as fuel, and the water may be separated into hydrogen and oxygen through electrolysis. In order to improve the function of the water electrolysis device 1000, a plurality of unit structures 300 including separators 301 and 302 and an electrochemical cell 310 may be provided and repeated to form a laminate 400. Looking at the components of the unit structure 300, the unit structure 300 may include a fuel electrode side separator 301 and an air electrode side separator 302, and the separators 301 and 302 may have the wall structure described in the embodiments. Accordingly, the structural stability of the separators 301 and 302 may be sufficiently secured during the manufacturing or operating process of the water electrolysis device 1000, so that the performance of the water electrolysis device 1000 may be improved.

In the case of an electrochemical cell 310, as an example, a solid oxide cell may be used. Specifically, the electrochemical cell 310 may include a fuel electrode 311, an air electrode 312, and an electrolyte 313 disposed therebetween. Here, in the case of the fuel electrode 311, a cermet layer including a metal phase and a ceramic phase may be included. Here, the metal phase may include a metal catalyst such as nickel (Ni), cobalt (Co), copper (Cu), or an alloy thereof, which acts as an electron conductor. The metal catalyst may be in a metal state or in an oxide state. In the case of the ceramic phase of the fuel electrode 311, it may include gadolinia-doped ceria (GDC), samaria-doped ceria (SDC), ytterbia-doped ceria (YDC), scandia-stabilized zirconia (SSZ), and ytterbia-ceria-scandia-stabilized zirconia (YbCSSZ). The air electrode 312 may include an electrically conductive material, such as an electrically conductive perovskite material such as lanthanum strontium manganite (LSM). Other conductive erovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal such as Pt may also be used. In some embodiments, the air electrode 312 may include a mixture of an electrically conductive material and an ionically conductive ceramic material. For example, the air electrode 312 may include about 10 wt % to about 90 wt % of an electrically conductive material (e.g., LSM, or the like) and about 10 wt % to about 90 wt % of an ionically conductive material. Here, the ionically conductive material may include a zirconia-based and/or ceria-based material. The electrolyte 313 may include stabilized zirconia. Specifically, the electrolyte 313 may include scandia-stabilized zirconia (SSZ), yttria-stabilized zirconia (YSZ), scandia-ceria-stabilized zirconia (SCSZ), scandia-ceria-yttria-stabilized zirconia (SCYSZ), scandia-ceria-ytterbia-stabilized zirconia (SCYbSZ), and the like.

Meanwhile, a case in which the electrochemical cell 310 is a solid oxide cell was described above, but the electrochemical cell 310 may also be a polymer electrolyte membrane cell.

Gaskets 321 and 322 may be disposed on the outside of the electrochemical cell 310 to prevent fluid from leaking out. Porous conductive layers 323 and 324 may be disposed between the separators 301 and 302 and the electrochemical cell 310. It is preferable that the porous conductive layers 323 and 324 have excellent oxidation resistance to maintain excellent electrical conductivity. In addition, as shown in the illustrated form, the porous conductive layers 323 and 324 may have a mesh structure, or the like, to allow fluid to pass therethrough.

As set forth above, according to an example of the present disclosure, in the case of a separator for an electrochemical device, a high level of structural stability may be exhibited. Therefore, when such a separator is applied to an electrochemical device, the performance may be improved and it may also be advantageous for miniaturization.

While example embodiments have been shown and described above, it will be apparent to those skilled in the art that modifications and variations could be made without departing from the scope of the present invention as defined by the appended claims.

What is claimed is:

1. A separator for an electrochemical device, comprising:
a main plate; and
a plurality of walls disposed on at least one of a first surface and a second surface of the main plate opposing each other,
wherein the plurality of walls include a plurality of first walls having a shape extending in a first direction, and a plurality of second walls having a shape extending in a second direction, different from the first direction,
wherein, among the plurality of first walls, some regions of two adjacent first walls overlap each other in a direction, perpendicular to the first direction and remaining regions of two adjacent first walls do not overlap each other, and
wherein, among the plurality of second walls, some regions of two adjacent second walls overlap each other in a direction, perpendicular to the second direction and remaining regions of two adjacent second walls do not overlap each other.

2. The separator for an electrochemical device of claim 1, wherein a plurality of units including the two adjacent first walls and the two adjacent second walls are provided.

3. The separator for an electrochemical device of claim 2, wherein in a unit, at least one of the two adjacent second walls is not disposed between the two adjacent first walls.

4. The separator for an electrochemical device of claim 3, wherein in the unit, the two adjacent first walls protrude from the main plate in opposite directions.

5. The separator for an electrochemical device of claim 4, wherein in the unit, the two adjacent second walls protrude from the main plate in opposite directions.

6. The separator for an electrochemical device of claim 5, wherein in the unit, at least one of the two adjacent first walls and at least one of the two adjacent second walls disposed on the first surface of the main plate have a first side surface disposed on a same level with respect to the first direction.

7. The separator for an electrochemical device of claim 5, wherein in the unit, at least one of the two adjacent first walls and at least one of the two adjacent second walls disposed on the other surface of the main plate have one side surface disposed on a same level with respect to the first direction.

8. The separator for an electrochemical device of claim 5, wherein in the unit, at least one of the two adjacent first walls disposed on the first surface of the main plate overlaps all regions of at least one of the two adjacent second walls disposed on the first surface of the main plate in the second direction.

9. The separator for an electrochemical device of claim 5, wherein in the unit, at least one of the two adjacent first walls disposed on the second surface of the main plate overlaps all regions of at least one of the two adjacent second walls disposed on the second surface of the main plate in the second direction.

10. The separator for an electrochemical device of claim 3, wherein the plurality of units are arranged repeatedly in a diagonal direction between the first direction and the second direction.

11. The separator for an electrochemical device of claim 3, wherein one of the plurality of units has at least one of the two adjacent first wall included therein and at least one of the two adjacent second wall included in an other unit at least partially overlapping in the first direction.

12. The separator for an electrochemical device of claim 2, wherein in a unit, at least one of the two adjacent second walls is disposed at a position adjacent to at least one of the two adjacent first walls in the first direction and a position adjacent to the first wall in the second direction.

13. The separator for an electrochemical device of claim 12, wherein in the unit, some regions of at least one of the two adjacent first walls overlaps a second wall adjacent to that first wall in the first direction in the first direction and remaining regions of that first wall do not overlap the adjacent second wall.

14. The separator for an electrochemical device of claim 12, wherein in the unit, some regions of at least one of the two adjacent first wall overlaps a second wall adjacent to that first wall in the second direction in the second direction and remaining regions of that first wall do not overlap the adjacent second wall.

15. The separator for an electrochemical device of claim 12, wherein in the unit, the two adjacent first walls are spaced apart from each other in a diagonal direction between the first direction and the second direction.

16. The separator for an electrochemical device of claim 12, wherein, based on a plan view viewed in a direction perpendicular to the first surface and the second surface of the main plate, all straight lines passing through at least one of the plurality of units meet at least one of the plurality of walls.

17. The separator for an electrochemical device of claim 12, wherein in the unit, at least one of the two adjacent first walls and at least one of the two adjacent second walls protrude in opposite directions with respect to the main plate.

18. The separator for an electrochemical device of claim 12, wherein in the unit, two first walls protrude in a same direction with respect to the main plate.

19. The separator for an electrochemical device of claim 12, wherein in the unit, two second walls protrude in the same direction with respect to the main plate.

20. The separator for an electrochemical device of claim 12, wherein the plurality of units are arranged repeatedly in the first direction and the second direction.

21. The separator for an electrochemical device of claim 12, wherein the plurality of units include a first unit and a second unit, and
a length of the first wall included in the second unit in the first direction is longer than a length of a first wall included in the first unit in the first direction.

22. The separator for an electrochemical device of claim 21, wherein the first unit is arranged repeatedly in the second direction.

23. The separator for an electrochemical device of claim 21, wherein the first wall included in the second unit has different protruding directions with respect to the main plate.

24. The separator for an electrochemical device of claim 21, wherein the second unit is provided in plural numbers, and a plurality of second units are arranged in the second direction.

25. The separator for an electrochemical device of claim 21, wherein the first unit is disposed on both sides of the main plate in the first direction, and
the second unit is disposed between first units disposed on both sides of the main plate.

26. The separator for an electrochemical device of claim 21, wherein the first unit is disposed on one side of the main plate in the first direction, and
the second unit is disposed on the second side of the main plate in the first direction.

27. The separator for an electrochemical device of claim 21, wherein the plurality of units are not repeated in the first direction.

28. The separator for an electrochemical device of claim 2, wherein the plurality of walls further include a plurality of third walls having a shape extending in a direction inclined with respect to the first direction and the second direction.

29. The separator for an electrochemical device of claim 28, wherein at least two of the plurality of third walls have different directions inclined with respect to the first direction and the second direction.

30. The separator for an electrochemical device of claim 28, wherein the plurality of third walls are disposed on both sides of the main plate in the first direction, and
a unit is disposed between the plurality of third walls disposed on both sides of the main plate in the first direction.

31. The separator for an electrochemical device of claim 30, wherein in the plurality of third walls, a third wall disposed on one side of the main plate in the first direction and a third wall disposed on the second side of the main plate protrude in opposite directions with respect to the main plate.

32. The separator for an electrochemical device of claim 1, wherein the first direction and the second direction are perpendicular to each other.

33. The separator for an electrochemical device of claim 1, wherein the main plate and the plurality of walls form an integral structure.

34. The separator for an electrochemical device of claim 1, wherein the plurality of walls have a shape in which the first surface and a second surface of the main plate protrude in the same direction.

35. The separator for an electrochemical device of claim 1, wherein the main plate includes a through-hole disposed on an outside of the plurality of walls in the first direction.

36. A separator for an electrochemical device, comprising:
a main plate; and
a plurality of walls disposed on at least one of a first surface and a second surface of the main plate opposing each other,
wherein the plurality of walls include a plurality of first walls having a shape extending in a first direction, and
wherein, among the plurality of first walls, at least two adjacent first walls protrude in opposite directions with respect to the main plate, and some regions of at least two adjacent first walls overlap each other in a direction, perpendicular to the first direction, remaining regions of at least two adjacent first walls do not overlap each other.

37. The separator for an electrochemical device of claim 36, wherein the plurality of first walls are arranged alternately in a direction inclined with respect to the first direction.

38. The separator for an electrochemical device of claim 36, wherein some regions of the plurality of first walls overlap two other adjacent first walls in a direction, perpendicular to the first direction, and remaining regions of the plurality of first walls do not overlap each other.

39. The separator for an electrochemical device of claim 36, wherein the plurality of walls further comprises a plurality of second walls having a shape disposed between the plurality of first walls and having a shape extending in a second direction, different from the first direction.

40. A separator for an electrochemical device, comprising:
a main plate; and
a plurality of walls disposed on at least one of a first surface and a second surface of the main plate, opposing each other,
wherein, based on a plan view viewed in a direction, perpendicular to the first surface and the second surface of the main plate, when a region excluding an outermost side of the main plate in which the plurality of walls do not exist is referred to as a flow path region, all straight lines passing through a center of the flow path region meet at least one of the plurality of walls.

41. The separator for an electrochemical device of claim 40, wherein all straight lines passing through the flow path region meet at least one of the plurality of walls.

42. The separator for an electrochemical device of claim 40, wherein the plurality of walls include a plurality of first walls extending in a first direction and a plurality of second walls having a shape extending in a second direction, different from the first direction.

43. An electrochemical device, comprising:
a plurality of separators; and
an electrochemical cell disposed between the plurality of separators,
wherein at least one of the plurality of separators includes:
a main plate; and
a plurality of walls disposed on at least one of a first surface and a second side of the main plate, opposing each other,
wherein the plurality of walls include a plurality of first walls having a shape extending in a first direction and a plurality of second walls having a shape extending in a second direction, different from the first direction,
wherein, among the plurality of first walls, some regions of two adjacent first walls overlap each other in the second direction and remaining regions of two adjacent first walls do not overlap each other, and
wherein, among the plurality of second walls, some regions of two adjacent second walls overlap each other in the first direction and remaining regions of two adjacent second walls do not overlap each other.

44. A separator for an electrochemical device, comprising:
a main plate having a first surface and a second surface opposing the first surface;
a set of first walls disposed to be protruding away from one or both of the first and second surfaces, and extending in a first direction along the first and second surfaces;
a set of second walls disposed to be protruding away from one or both the first and second surfaces, and extending in a second direction along the first and second surfaces,
wherein in a flow path region defined as a region excluding outermost edges of the main plate in which the plurality of walls do not exist, all straight lines passing through the flow path region meet at least one wall among the first and second walls.

45. The separator of claim 44, wherein only a portion of two adjacent first walls overlaps in the first direction.

46. The separator of claim 44, wherein only a portion of two adjacent second walls overlaps in the second direction.

47. The separator of claim 44, further comprising a plurality of units having centers thereof arranged in a virtual line along the first or second surfaces of the main plate,
wherein each of the plurality of units comprises:
two adjacent first walls, and
two adjacent second walls selected to overlap at least partially with the two adjacent first walls.

48. The separator of claim 47, wherein the virtual line forms a non-zero angle with the first and/or the second direction.

49. The separator of claim 47, wherein the first walls and the second walls in adjacent of the plurality of units protrude in opposite directions relative to the main plate.

50. A separator for an electrochemical device, comprising:
a main plate having a first surface and a second surface opposing the first surface;
a set of first walls extending in a first direction along the first and second surfaces, wherein a first of two adjacent first walls protrudes away from the first surface and a second of the two adjacent first walls protrudes away from the second surface;
a set of second walls extending in a second direction along the first and second surfaces, wherein a first of two adjacent second walls protrudes away from the first surface and a second of the two adjacent second walls protrudes away from the second surface,
wherein only a portion of the two adjacent first walls overlaps in the first direction and only a portion of the two adjacent second walls overlaps in the second direction.

51. The separator of claim 50, further comprising a set of first units having centers thereof arranged in a virtual line along the first or second surfaces of the main plate,
wherein each of the first units comprises:
two adjacent first walls, and
two adjacent second walls selected to overlap at least partially with the two adjacent first walls.

52. The separator of claim 51, wherein the virtual line is disposed along one or both of the first direction and the second direction.

53. The separator of claim 51, further comprising a set of second units each disposed between two adjacent first units, each of the second units comprising:
two adjacent first walls, and
two adjacent second walls selected to overlap at least partially with the two adjacent first walls,
wherein a length of the first walls included in the first units is longer than a length of the first walls included in the second units.
